(19) United States
(12) Patent Application Publication
(10) Pub. No.: US 2005/0052116 A1
(43) Pub. Date: Mar. 10, 2005

(54) Flat panel backlight and liquid crystal display device using the same

(76) Inventors: Tomio Yaguchi, Sagamihara (JP); Nobuaki Hayashi, Kunitachi (JP); Makoto Okai, Tokorozawa (JP); Takahiko Muneyoshi, Musashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/937,384

(22) Filed: Sep. 10, 2004

(30) Foreign Application Priority Data
Sep. 10, 2003 (JP) 2003-318207

(51) Int. Cl. H01J 1/62; H01J 63/04

(52) U.S. Cl. 313/493; 313/311

(57) ABSTRACT

To obtain an image display of high image quality with a high and contrast with the least blurring, an electron beam source panel includes cathodes which emit electron beams and control electrodes which control the strength of the electron beams, and a phosphor screen panel includes a light emitting surface having a phosphor capable of emitting light of the same color over the whole light emitting surface and anodes to which a potential is supplied necessary for the phosphor. The electron beam source panel and the phosphor screen panel are laminated to each other by way of spacers, the laminated structure is sealed by a frame glass and the inside of the sealed structure is evacuated to create a vacuum therein. The light emitting surface is divided in three or more regions, thus providing a flat panel backlight which selectively allows only some portions of the divided light emitting surface to emit light.

### BACKGROUND OF THE INVENTION

The present invention relates to a backlight of the type used in combination with a liquid crystal element; and, more particularly, the invention relates to a flat panel backlight forming a field emission light emitting element which uses a cold cathode material which generates an electron emission in a relatively low electric field, particularly to a carbon-oriented material, such as carbon nanotubes, fine carbon fibers, diamond or the like, without being heated to a high temperature, and the invention relates further to a liquid crystal display device which combines the flat panel backlight and a liquid crystal element.

A thin light source, which utilizes the emission of light obtained by the radiation of electron beams emitted from a cathode (a linear cathode) to a phosphor, in the same manner as a cathode ray tube, as a backlight of a liquid crystal display device, is described in Japanese Unexamined Patent Publication Sho63(1988)-10458 (patent literature 1). In this patent literature 1, a thin light source is described which includes a plurality of linear electron sources and a plurality of mesh-like electrodes and which makes the whole screen produce a monochroic uniform light emission by adjusting the brightness with control of the width of drive pulses.

Further, Japanese Unexamined Patent Publication Hei11(1999)-7016 (patent literature 2) discloses a liquid crystal display device which is capable of performing a color display by arranging phosphors of different light emitting colors in conformity with pixels of a using liquid crystal element without providing color filters on the liquid crystal element side. Further, Japanese Unexamined Patent Publication Hei11(1999)-64820 (patent literature 3) discloses a liquid crystal display device which uses field emission electron sources as cathodes and includes a phosphor screen capable of selectively emitting lights of a plurality of colors, thus enabling a color display to be produced by performing light emission control of a flat panel backlight and display pixel control of a liquid crystal element in synchronism.

### SUMMARY OF THE INVENTION

As indicated in the above-mentioned publications, by making use of the emission of light, which is obtained by radiating electron beams to phosphors, as the backlight of a liquid crystal element, it is possible to obtain a liquid crystal display device which can perform brightness control with high brightness. Accordingly, it is possible to obtain a liquid crystal display device having a high image quality with high peak brightness compared to a liquid crystal display device which uses fluorescent lamps, a light guide plate and a dispersion plate as a backlight.

However, in the structure disclosed in patent literature 1, since it is necessary to arrange a plurality of linear electron sources at given positions in a distributed manner, the density of the electron linear sources is increased, whereby it is difficult to increase the uniformity, thus increasing the manufacturing cost. Further, the light emission state of a phosphor screen is uniform over the whole screen, and, hence, to avoid degradation of the image quality when a moving image is displayed, that is, to prevent moving image blurring, the method of driving the liquid crystal element becomes complicated.

Further, to construct a structure which allows for selective emission of lights of plural colors, as disclosed in patent literature 2, it is necessary to strictly align the loci of electron beams which constitute an excitation source of the phosphors with the arrangement of the phosphors and, further, with the arrangement of pixels of the liquid crystal element; and, hence, a restriction is imposed on the setting of the strength of the electron beams, or the manufacturing cost is increased due to this alignment.

A measure to cope with the moving image blurring problem is disclosed in patent literature 3. In patent literature 3, the emission of lights of a plurality of colors is sequentially performed on a panel, and a non-light-emission state is inserted at the time of rewriting the pixels of the liquid crystal element so as to suppress the generation of moving image blurring. However, in patent literature 3, it is also necessary to selectively emit lights of a plurality of colors, and, hence, in the same manner as patent literature 2, it is necessary to align the loci of the electron beams with the arrangement of the phosphors. Due to this alignment, a restriction is imposed on the setting of the strength of the electron beams. Further, since the color images are sequentially displayed on the panel, it is necessary to drive the display device at a speed three times or more faster than the speed of the usual driving method. Because of the necessity for alignment, the necessity of providing a panel structure which enables high-speed driving and the necessity of providing a drive device which can cope with the high-speed driving, the manufacturing cost is increased.

Accordingly, it is an object of the present invention to provide a flat panel backlight which can generate uniform illumination light with high brightness over the whole light emitting surface, and a liquid crystal display device of high quality which uses such a flat panel backlight.

To achieve the above-mentioned object, the flat panel backlight of the present invention is constituted of a cathode panel including cathodes which have field emission electron sources formed of a material capable of emitting electrons with a low electric field and control electrodes which control the strength of electron beams emitted from the cathodes, and a phosphor screen panel including a light emitting surface which has a phosphor capable of emitting light with the same color over the whole light emitting surface and an anode to which a potential is supplied necessary for the phosphor. Further, the liquid crystal display device of the present invention, which uses the flat panel backlight, can suppress moving image blurring by allowing the selective light emission of a portion of the whole light emitting surface, thus realizing a moving image display of high quality.

As the above-mentioned electron emission material which enables the acquisition of electron emission with a low electric field, field emission electron sources which use diamond, carbon nanotubes, fine carbon fibers or the like are used as the cathodes. Then, by adopting a drive method which enables the selective light emission of a portion of the whole light emitting surface of the phosphor screen panel by controlling the voltage applied to the control electrodes and the cathodes, it is possible to obtain a liquid crystal display device of high quality which exhibits a high brightness and which can reduce the moving image blurring. Representative constitutions of the present invention.

The flat panel backlight of the present invention divides the light emitting surface, having white as a light emitting color, into three or more regions, and only some divided regions of the light emitting surface are selectively allowed to emit light.

The cathodes and the control electrodes are substantially formed on the same plane and the difference between the length of a perpendicular which is extended downwardly onto an anode surface from a first point, which is an arbitrary point on the cathode, and the length of a perpendicular which is extended downwardly onto the anode surface from a second point, which is an arbitrary point on the control electrode closest to the first point on the cathode, is equal to or smaller than either larger film thickness out of the film thickness of the cathode at the first point and the film thickness of the control electrode at the second point.

Further, in the liquid crystal display device of the present invention, at least one of the number of divisions of the light emitting surface and the flickering periods of respective divided regions is changed in response to at least one of the selection signals obtained, based on a selection signal or a video signal received from the outside with respect to the flat panel backlight. Further, the liquid crystal display device of the present invention includes a drive device which can select the light emission strength of the phosphor of the flat panel backlight and the optical transmissivity of the liquid crystal element.

The present invention is not limited to the above-mentioned constitutions and the constitutions of embodiments to be explained later, and various modifications can be made without departing from the technical concept of the present invention.

As has been explained heretofore, according to the present invention, by adopting a flat panel light emitting element, which uses field emission electron sources that are capable of performing line-scanning-type monochroic light emission, as a backlight which illuminates a liquid crystal panel part, it is possible to obtain a flat panel backlight which is capable of obtaining an image display with the least degradation of image quality, such as blurring on the moving image, in particular. Further, by setting the light emission strength of the flat panel backlight at a high brightness partially and for a short time so as to properly control the optical transmissivity of the liquid crystal element, it is possible to effectively improve the contrast with only a slight increase of the power consumption, and, hence, it is possible to provide a liquid crystal display device which is capable of producing a high quality display.

### BRIEF DESCRIPTION OF THE DRAWINGS

FIG. 1 is a perspective view which diagrammatically illustrate the constitution of a first embodiment of a flat panel backlight according to the present invention;

FIG. 2 is a cross-sectional view taken along a plane A in FIG. 1 showing the first embodiment of the flat panel backlight according to the present invention;

FIG. 3 is a perspective view diagrammatically illustrating the first embodiment of a liquid crystal display device according to the present invention;

FIG. 4 is a cross-sectional view taken along a line B-B′ in FIG. 3 for illustrating optical path from the flat panel backlight;

FIG. 5 is a perspective view diagrammatically illustrating a second embodiment of the flat panel backlight according to the present invention;

FIG. 6 is a cross-sectional view taken along a plane C in FIG. 5;

FIG. 7 is a sectional view diagrammatically illustrating a third embodiment of the flat panel backlight according to the present invention;

FIG. 8 is a perspective view diagrammatically illustrating a fourth embodiment of the flat panel backlight according to the present invention;

FIG. 9A is a cross-sectional view taken along a plane D in FIG. 8, and

FIG. 9B is a detailed view of area E in FIG. 9A; and

FIG. 10 is a cross-sectional view, similar to FIG. 9, diagrammatically illustrating a fifth embodiment of the flat panel backlight according to the present invention.

### DETAILED DESCRIPTION OF THE INVENTION

Preferred embodiments of the display device of the present invention will be explained in detail hereinafter in conjunction with the drawings.

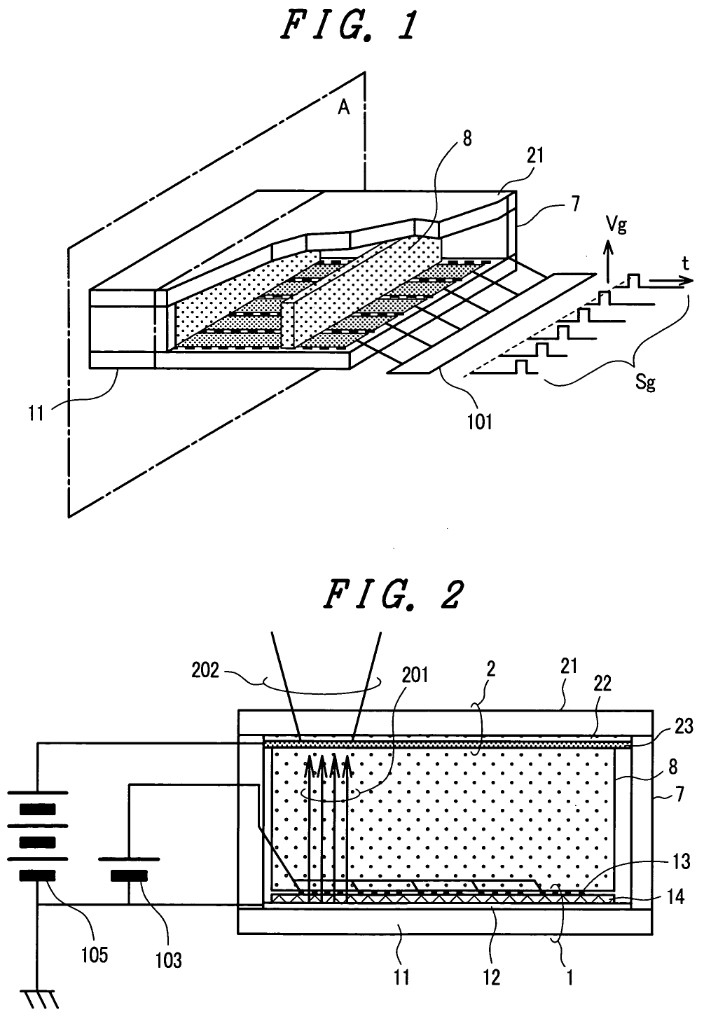

FIG. 1 is a perspective view showing the constitution of a first embodiment of a flat panel backlight according to the present invention.

Further, FIG. 2 is a cross-sectional view taken along a plane A in FIG. 1. The flat panel backlight of this embodiment is of a type in which a light emitting region is divided by a plurality of control electrodes. Here, FIG. 2 shows the constitution of the electrodes and the voltage applied state.

In this embodiment, to ensure the required conductivity in a region which corresponds to the light emitting region on an electron beam source panel glass substrate 11, a silver paste is printed and baked to form a background having a thickness of 5 μm. Thereafter, a paste containing 10% by weight of carbon fibers, mainly formed of the carbon nanotubes having a length of 5 μm, is printed and baked, thus forming cathodes 12. Over these cathodes 12, insulation stripes 14 are printed and formed at an interval of 1 mm using a dielectric paste, such that the insulation stripe 14 has a height of 30 μm and a width of 50 μm. Over the insulation stripes 14, control electrodes 13, each of which is formed of a thin plate made of Invar material in which opening portions having a diameter of 50 μm are formed by etching, are arranged in the direction orthogonal to the insulation stripes 14 and are fixed using frit glass (not shown in the drawing), thus forming a cathode panel, that is, an electron beam source panel 1.

On the other hand, with respect to the phosphor screen panel 2, phosphor 22 is formed on a light emitting region over a phosphor screen panel glass substrate 21 by printing, and, thereafter, the phosphor 22 is baked. Then, aluminum which constitutes an anode 23 is formed on the phosphor 22 by a vapor deposition method. The electron beam source panel 1 and the phosphor screen panel 2, which are formed in the above-mentioned manner, are bonded to each other by way of a frame glass 7 and spacers 8, and the inside is evacuated to create a vacuum state therein. The spacers 8 used in this embodiment have a rib shape with a trapezoidal cross section in which the width thereof on the electron beam source panel 1 side is 500 μm and the width thereof on the phosphor screen panel 2 side is 300 μm and the height thereof is 6 mm. Further, the spacers 8 are arranged to be parallel to the insulation stripes 14.

The cathodes 12 are set to 0V, while 20 kV is applied to the anode 23 using an anode power source 105. Since a plurality of control electrodes 13 are provided, the control electrodes 13 are connected with a control electrode drive circuit 101; and, as shown in FIG. 1, a control electrode selection signal Sg is sequentially applied to the control electrode drive circuit 101, and a selection voltage Vg is applied to respective control electrodes line after line. In this case, as shown in FIG. 2, a positive voltage (+300V in this embodiment) is applied to the control electrode 13 corresponding to the region which is selected for electron emission, while the control electrodes 13 corresponding to the region from which the electrons are not allowed to be emitted are set to the same potential as the potential of the cathode 12. Here, in FIG. 2, numeral 103 indicates a control electrode power source, numeral 105 indicates an anode power source, numeral 201 indicates electron beams, and numeral 202 indicates light emission from the phosphor.

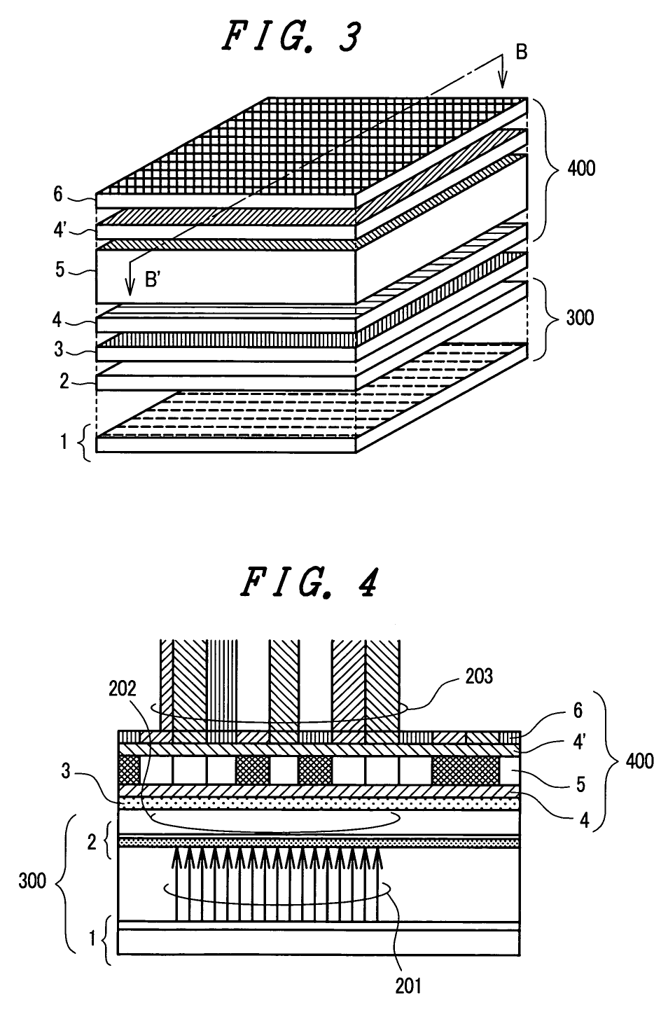

FIG. 3 is a perspective view showing the constitution of the first embodiment of a liquid crystal display device according to the present invention. Further, FIG. 4 is a cross-sectional view taken along a line B-B′ in FIG. 3, showing an optical path from the flat panel backlight. As shown in FIG. 4, the liquid crystal display device is constituted by mounting a flat panel backlight part 300 on a back surface of a liquid crystal panel part 400, consisting of a lower polarizer 4, a liquid crystal element 5, an upper polarizer 4′ and color filters 6.

Here, although not shown in the drawing, the liquid crystal element 5 includes a plurality of selection line electrodes and a plurality of signal line electrodes, which intersect the selection line electrodes on an inner surface of one of two glass substrates, and active elements, such as thin film transistors, are formed on intersecting portions between the selection line electrodes and the signal line electrodes. Video data transmitted from the signal line electrodes is written in the thin film transistors of the lines selected by the selection line electrodes. Further, the control electrodes 13 (see FIG. 2) of the flat panel backlight part 300 are arranged to be parallel with the selection line electrodes of the liquid crystal element, wherein by selecting the control electrodes 13, sequentially line after line, light is emitted from the whole surface sequentially so as to illuminate the liquid crystal panel part 400.

However, since the electron beams are not radiated to regions where the spacers 8 shown in FIG. 1 and FIG. 2 are present, linear thin shaded areas appear on the light emitting surface at positions where the spacers 8 are located. Accordingly, in the liquid crystal display device of this embodiment, to conceal the brightness irregularities attributed to the influence or the like of the spacers 8, which are observed in case the flat panel backlight part 300 is used as a single body, a light scattering plate 3 is overlapped relative to the phosphor screen panel 2 of the flat panel backlight part 300.

In the combination for constituting the liquid crystal display device by combining the flat panel backlight part 300 and the liquid crystal panel part 400, out of the matrix structure which is constituted of the selection line electrodes and the pixel data electrodes for performing the rewriting of the pixel data of the liquid crystal element 5, the selection line electrodes are formed in parallel with the above-mentioned control electrodes 13 of the flat panel backlight part 300.

Due to the above-mentioned constitution, by radiating the electron beams 201 from the electron beam source panel 1 to the phosphor screen panel 2, the emission of light from the phosphor 202 becomes uniform due to the effect of the light scattering plate 3, and the transmitting light 203 is generated only in the light required regions through the lower polarizer 4, the liquid crystal element 5 and the upper polarized 4′; and, thereafter, the emission of light is colored by the color filters 6, thus realizing the display of a color image.

The flat panel backlight part 300 side merely sequentially emits light, and so it is unnecessary to provide any correspondence with the pixels on the liquid crystal panel part 400 side; and, hence, the accurate alignment of the flat panel backlight part 300 and the liquid crystal panel part 400 is unnecessary even at the time of assembling. In driving the liquid crystal display device, while taking into consideration the synchronism between the line electrode selection signal for rewriting the pixel data of the liquid crystal element 5 and the selection signal of the control electrode drive circuit 101 of the flat panel backlight part 300, the liquid crystal display device is driven by shifting the phases of these signals to prevent these signals from simultaneously selecting the same regions. Accordingly, at the time of rewriting the pixels of the liquid crystal element 5, it is possible to perform driving such that the emission of light at the corresponding regions of the flat panel backlight part 300 is stopped, whereby it is possible to suppress the generation of a deterioration of a moving image (so-called moving image blurring) attributed to the simultaneous recognition of the states of pixels before and after the rewriting.

Here, in the liquid crystal display device of this embodiment, the control electrodes 13 are divided into six electrodes, and the emission of light is performed only at some divided sections. In this case, the division number may be set to a most proper number by taking the light emission characteristics of the phosphor 22 and the constitution of the control electrode drive circuit 101 into consideration. However, it is difficult to obtain a light extinction state in which the emission of light is completely stopped at boundary portions between the divided regions, and, hence, it is desirable to surely hold the light emission stop state by dividing the control electrodes 13 into three or more electrodes.

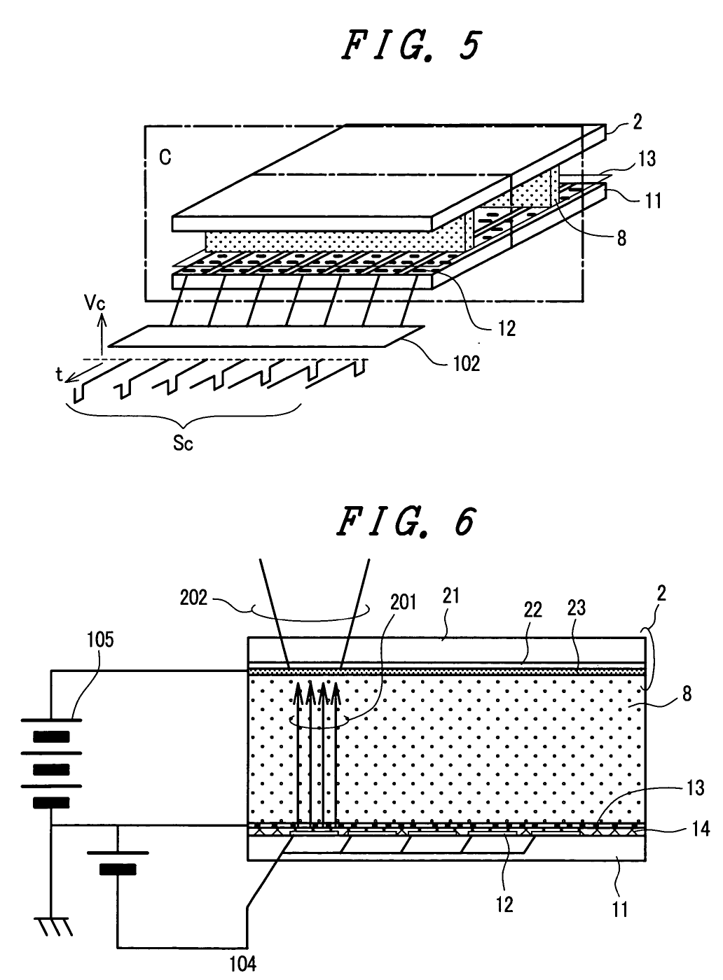

FIG. 5 is a perspective view showing the constitution of a second embodiment of the flat panel backlight according to the present invention. FIG. 6 is a cross-sectional view taken along a plane C in FIG. 5. The flat panel backlight of this embodiment is configured such that the light emitting region is divided by dividing the cathodes. That is, in the above-mentioned first embodiment of the flat panel backlight, the light emitting region is divided by dividing the control electrodes 13. However, as in the case of this embodiment, the light emitting region may be divided by dividing the cathodes 12.

In the flat panel backlight of this embodiment, on the electron beam source panel glass substrate 11, background electrodes having a width of 100 μm are printed at an interval of 20 μm using a silver paste and are baked. Thereafter, the cathodes 12 having a thickness of 5 μm are formed on the background electrodes using a paste containing 10% by weight of carbon fibers. Further, insulation stripes 14, having a width of 40 μm and a height of 40 μm, are formed by focusing on the spacer portions between the cathodes such that the insulation stripes 14 are arranged parallel to the longitudinal direction of the cathodes 12 using a dielectric paste. Onto the insulation stripes 14, the control electrodes 13 are fixed using frit glass. Here, the control electrodes 13 are formed of a thin plate which has opening portions with a diameter of 50 μm over the whole region thereof, to which electrons from the cathodes are emitted. The electron beam source panel 1, which is formed in the above-mentioned manner, is combined with the phosphor screen panel in the same manner as the first embodiment, and the inside thereof is evacuated to create a vacuum state therein.

In driving the flat panel backlight, the control electrodes 13 are set to 0V, and 20 kV is applied to the anodes 23 from the anode power source 105. Since a plurality of cathodes 12 are provided, the cathodes 12 are connected with a cathode drive circuit 102; and, as shown in FIG. 5, a cathode selection signal Sc is sequentially applied to the cathode drive circuit 102, and a selection voltage Vc is applied to respective cathodes, line after line. In this case, as shown in FIG. 6, a negative voltage (−300V in this embodiment) is applied to the cathodes 13 corresponding to the region which is selected for electron emission from the cathode power source 104, while the cathodes corresponding to the region from which the electrons are not allowed to be emitted are set to the same potential as the potential of the control electrodes 13. By sequentially selecting the electrodes line after line of the cathodes 12, it is possible to obtain a flat panel backlight part 300 which allows the whole surface to sequentially emit light. Since the electron beams are not radiated to regions where the spacers 8 are present, linear thin shaded areas appear on the light emitting surface at positions where the spacers 8 are located. In view of this drawback, also in this embodiment, a light scattering plate 3, similar to the light scattering plate 3 of the flat panel backlight in the first embodiment, is overlapped relative to the phosphor screen panel 2 of the flat panel backlight part 300.

The flat panel backlight part 300, which is obtained in the above-mentioned manner, in the same manner as the liquid crystal display device of the first embodiment, in combined with the liquid crystal panel part 400 shown in FIG. 3 and FIG. 4, thus constituting the liquid crystal display device of the second embodiment of the present invention. Here, the liquid crystal display device is driven such that the divided cathodes 12 are arranged parallel to the selection line electrodes for rewriting pixel data of the liquid crystal element 5; and, at the same time, the cathode drive circuit 102 is driven such that the selection signals are synchronized with the line electrode selection signals of the liquid crystal panel part 400. By constituting the liquid crystal display device of the second embodiment by combining the flat panel backlight of this embodiment, it is possible to obtain a performance that is substantially equal to the performance of the liquid crystal display device of the first embodiment.

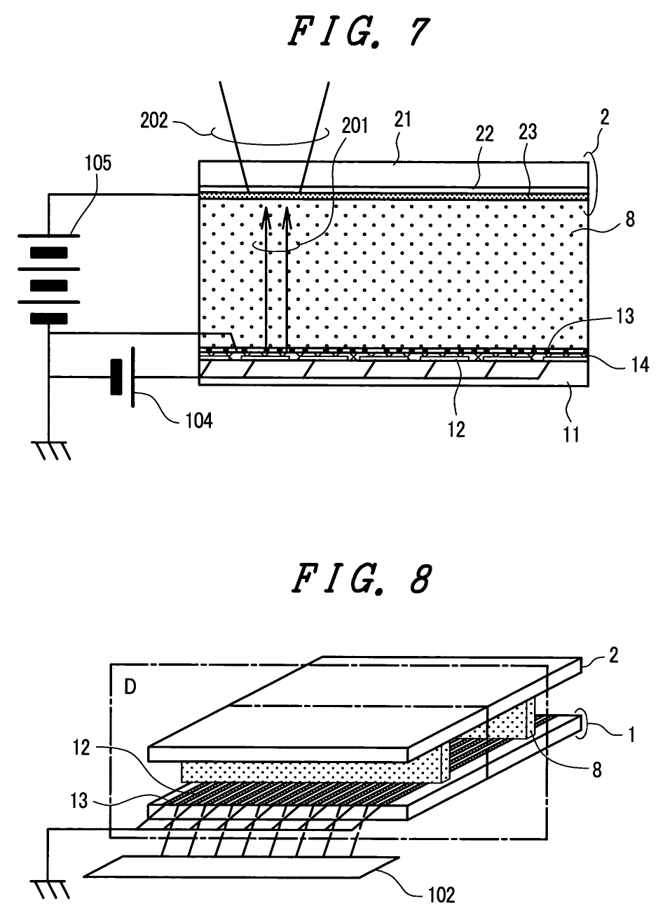

FIG. 7 is a perspective view showing the constitution of the third embodiment of the flat panel backlight according to the present invention. In the above-explained second embodiment, carbon fibers are used as the electron emission material which is contained in the cathodes 12. However, the advantageous effects of the present invention do not depend on the kind of the electron emission material, and it is apparent that substantially the same advantageous effects can be obtained by using a material such as carbon nanotubes, diamond, diamond-like carbon, from which the electron emission characteristics of substantially the same level can be expected. However, when electron emission material such as a kind of carbon nanotubes which can obtain the emission of electrons with a further lower electric field is used, there exists a possibility that the emission of electrons is generated even when the control electrodes 13 and the cathodes 12 assume the same potential in the above-mentioned non-selected state. In such a case, by adopting a drive method which uses cutoff electrodes, which can make the potential of the cathodes 12 have the positive potential higher than the potential of the control electrode, it is possible to obtain substantially the same advantageous effect. The drive voltage state in such a case is shown in FIG. 7. FIG. 7 shows an electrode constitution which is the same as the electrode constitution shown in FIG. 6 except only for the point that the polarity of the cathode power source 104 in FIG. 7 is opposite to the polarity of the cathode power source 104 in FIG. 6.

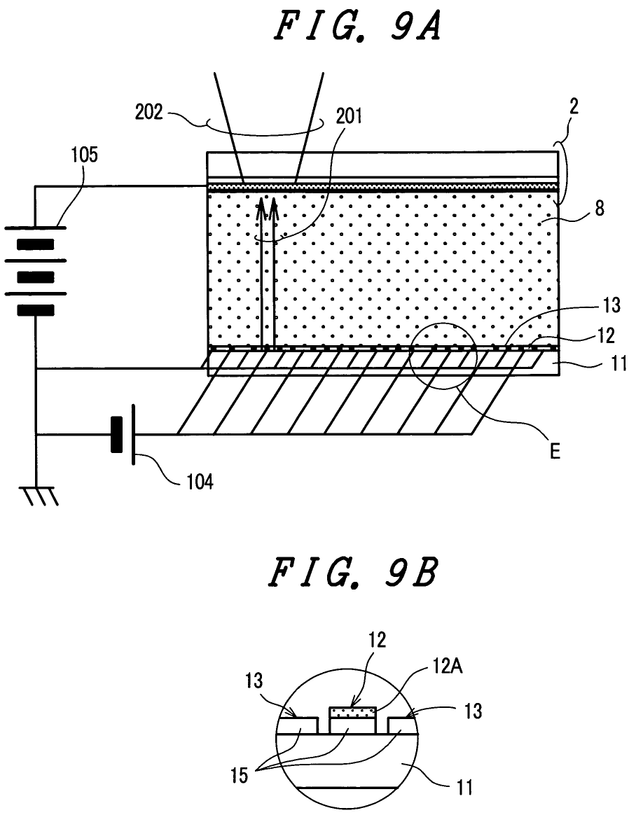

FIG. 8 is a perspective view showing the constitution of a fourth embodiment of the flat panel backlight according to the present invention. FIG. 9A is a cross-sectional view taken along a plane D in FIG. 8. Here, a representative part E in FIG. 9A is shown in an enlarged manner in FIG. 9B. In the above-mentioned embodiments 1 to 3, thin plates having opening portions are used as the control electrodes 13. However, it is possible to obtain substantially the same advantageous effects by adopting an electrode structure in which the control electrodes 13 and the cathodes 12 are formed in a stripe pattern on substantially the same or a coplanar plane. In this embodiment, the phosphor screen panel 2 has the same structure as the phosphor screen panel 2 of the first embodiment. On the other hand, the electron beam source panel 1 side is constituted as follows.

First of all, background electrodes 15 having a thickness of 5 μm are formed on the electron beam source panel glass substrate 11 in a stripe pattern such that both the line width and the interval thereof become 30 μm.

Thereafter, a paste containing 10% by weight of carbon nanotubes is printed on every other background electrode 15 and is baked, thus forming carbon nanotube layers 12A having a thickness distribution which has the center thereof at approximately 2 μm. Due to such a constitution, it is possible to obtain an electron beam source panel 1 in which the carbon nanotube layers 12A constitute the cathodes 12 and the electrodes on which the paste is not printed directly constitute the control electrodes 13.

Here, among the group of background electrodes 15 which are arranged in a stripe pattern, it is necessary to use the background electrodes 15 arranged at both sides of the background electrode 15 on which the carbon nanotube layers 12A are formed as the control electrodes 13.

Accordingly, the total number of effective control electrodes 13 and cathodes 12 becomes an odd number. Further, in this embodiment, the difference in height between the control electrodes 13 and the cathodes 12 is generated as a difference in film thickness between the control electrodes 13 and the cathodes 12, including the thickness of the carbon nanotubes. However, it is ideal when the heights of the control electrodes 13 and the cathodes 12 are equal.

When the difference in height between the control electrodes 13 and the cathodes 12 is large, there exists a possibility that an unnecessary diffusion of electron beams is induced, and, hence, it is desirable to set the difference in height between them to a small value. Even when the difference may become large, the difference should be suppressed to approximately the film thickness of either one of the control electrodes 13 and the cathode 12 having the larger thickness. To this end, the formation thickness of the carbon nanotube layer 12 is set to be smaller than the formation thickness of the background electrodes 15.

The obtained electron beam source panel 1, in the same manner as the first embodiment, is bonded to the phosphor screen panel 2 by way of the frame glass 7 and the spacer 8, and the inside thereof is evacuated to create a vacuum. The spacers 8 used in this embodiment are substantially the same as the spacers 8 of the first embodiment shown in FIG. 2.

In driving the flat panel backlight, all control electrodes 13 are set to 0V, and 20 kV is applied to the anodes 23 by the anode power source 105. The cathode drive circuit 102 is connected with the anodes 12. To the cathodes 12 which are selected for generating an electron emission, a voltage is applied such that these cathodes 12 assume the same potential as the control electrodes 13, and the cathodes 12 in a non-selected state, which are not allowed to emit the electrons, assume the positive potential (+200V in this embodiment). The cathodes 12 of this embodiment, which are formed by printing a paste which uses the carbon nanotubes 12A as the electron emission material, have characteristics such that the cathodes 12 can obtain the required electron emission strength with an electric field of 3V/μm, which is generated due to the potential difference between the anode 23 and the cathode 12. Required electron emission is obtained from the cathodes 12 in the selected state to which the potential of 0V is applied.

On the other hand, the average electric field between the anodes 23 and the cathodes 12 is shielded by the neighboring control electrodes 13;
and, hence, the electric field on the surface of the cathodes 12 in a non-selected state, to which the voltage of positive potential is applied, is suppressed, whereby the emission of electrons is interrupted. Accordingly, the emission of electrons is partially generated in response to the selection signal applied to the cathodes 12, and, hence, it is possible to generate a partial emission of light corresponding to the electron emission regions.

The liquid crystal display device is formed by combining the flat panel backlight part 300 having the above-mentioned constitution with the optical scattering plate 3 and the liquid crystal panel part 400 shown in FIG. 3 in the same manner as the first to the third embodiments. Also, in this liquid crystal display device, it is possible to obtain an image display of high quality with no blurring with respect to a moving image.

In this embodiment, in the same manner as the above-mentioned second embodiment, the cathode side is divided in plural numbers. However, in the second embodiment, it is necessary to form the insulation stripes 14 using a dielectric paste which exhibits an inferior printing accuracy, and so it is necessary to manufacture the control electrodes 13 having the opening portions separately. To the contrary, in the liquid crystal display device which adopts the electrode structure of this embodiment, the electrodes can be formed by printing without using a dielectric paste. Accordingly, it is possible to obtain an advantageous effect in that the flat panel backlight part 300 can be manufactured at a lower cost.

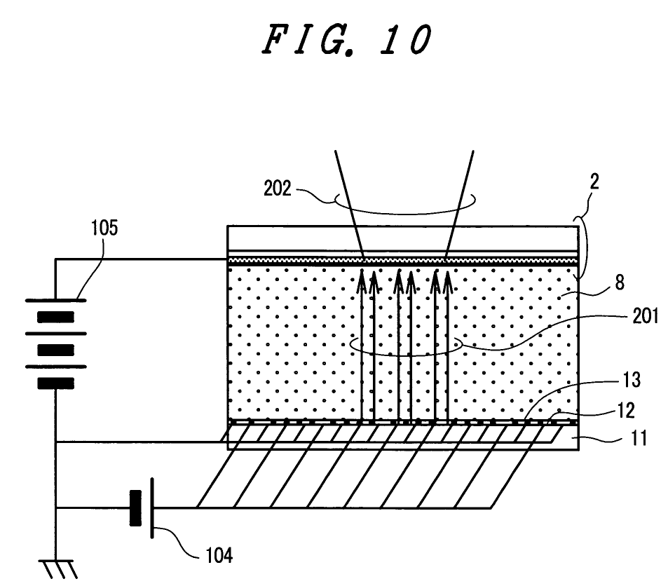

FIG. 10 is a cross-sectional view similar to FIG. 9A showing the constitution of a fifth embodiment of the flat panel backlight according to the present invention. In any one of the above-mentioned first to fourth embodiments, only one cathode 12 out of the plurality of cathodes 12 is set in the selected state with respect to the illustrated flat panel backlight part. However, as shown in FIG. 10, the cathodes 12 may be turned on sequentially by setting the plurality of electrodes in the selected state simultaneously. When the number of divisions is large, the respective regions perform emission of light in a mode close to the pulse light emission and have to be driven in response to drive signals having a high frequency component. Here, since the power consumption of the drive system which contains AC components is proportional to the frequency of the drive signals, the power consumption becomes relatively large. Accordingly, in this embodiment, the plurality of electrodes is simultaneously set in the selected state so as to decrease the number of divisions, and, hence, low frequency driving can be realized, whereby the power consumption can be reduced. Further, it is also possible to drive the flat panel backlight part such that, when a still image or an image of slow motion is to be displayed, the plurality of electrodes are simultaneously selected to perform low frequency driving; while, when a fast moving image is to be displayed, the number of divisions is increased to make the respective regions perform pulse light emission, so that an effective power consumption can be realized.

It has been known that, in the display of a moving image, by producing a display of high brightness instantaneously and partially, the contrast of the image can be enhanced, and, hence, a viewer can improve the image quality that he/she recognizes. The liquid crystal display device according to the present invention is superior to the related art also with respect to this point.

In the above-mentioned embodiments, as shown in FIG. 4, in the liquid crystal display device, the light generated from the phosphor 202 on the phosphor screen panel 2 is made uniform by the light scattering plate 3, and the transmitting light 203 is generated only with respect to the pixels which are necessary for forming the image by the liquid crystal panel part 400. Accordingly, at the time of causing the region which includes the pixels requiring high brightness to emit light, by increasing the strength of the electron beams 201 radiated to the phosphor screen panel 2, it is possible to obtain pixels which emit light with high brightness. With respect to the pixels which belong to the region of the phosphor screen panel 2 to which the pixels which produce high brightness light emission also belong, and which perform the emission of light at normal brightness, since the brightness of the phosphor screen panel 2 is elevated, it is possible to obtain proper brightness by lowering the transmissivity in the liquid crystal panel part 400. With the use of the phosphor 22 having the proper properties in the emission of light due to the radiation of electron beams 201 to the phosphor 22, high-speed switching can be realized. Further, since it is sufficient to impart high brightness to the required regions on the phosphor screen panel 2, it is possible to obtain a high quality image with only a high contrast with the slight increase in the power consumption.

1. A flat panel backlight which is arranged on a back surface of a liquid crystal element for imparting illumination light to the liquid crystal element, the flat panel backlight comprising:
an electron beam source panel including cathodes which emit electron beams and control electrodes which control the strength of the electron beams emitted from the cathodes; and
a phosphor screen panel including a light emitting surface which has a phosphor capable of emitting light with the same color over the whole light emitting surface in response to the electron beams and an anode to which a potential is supplied, wherein
the light emitting surface is divided in three or more regions and only some divided regions of the light emitting surface are selectively allowed to emit light.

2. A flat panel backlight according to claim 1, wherein the light emitting color of the phosphor is white.

3. A flat panel backlight according to claim 1, wherein the cathodes and the control electrodes are formed on substantially the same plane and the difference between the length of a perpendicular which is extended downwardly onto an anode surface from a first points which is an arbitrary point on the cathode, and the length of a perpendicular which is extended downwardly onto the anode surface from a second point, which is an arbitrary point on the control electrode closest to the first point on the cathode, is equal to or smaller than either larger film thickness out of the film thickness of the cathode at the first point and the film thickness of the control electrode at the second point.

4. A flat panel backlight according to claim 1, wherein a main component of an electron emission material which directly generates electron emission out of a material which constitutes the cathodes is selected from a group consisting of carbon nanotubes, fine carbon fibers, diamond and diamond-like carbon.

5. A liquid crystal display device comprising at least:
a liquid crystal element capable of changing the optical transmissivity for every pixel using liquid crystal; and
a flat panel backlight comprising at least an electron beam source panel including cathodes which emit electron beams and control electrodes which control the strength of the electron beams emitted from the cathodes; and
a phosphor screen panel including a phosphor capable of emitting light with the same color over the whole light emitting surface by radiating the electron beams and an anode to which a current is supplied, wherein
the light emitting surface of the phosphor screen panel is divided in three or more regions and only some divided regions of the light emitting surface are selectively allowed to emit light.

6. A liquid crystal display device according to claim 5, wherein in which the emitting light color of the phosphor is white, and color filters are Provided on a front surface of the liquid crystal element.

7. A liquid crystal display device according to claim 5, wherein the flat panel backlight performs a light emission control such that, at the time of performing a change of state of optical transmissivity of the pixels in the liquid crystal element, the flat panel backlight performs light emission control in synchronism with driving of the liquid crystal element which suppresses the emission of light of the phosphor in the corresponding region when the change of state of the optical transmissivity is generated.

8. A liquid crystal display device according to claim 5, wherein the cathodes and the control electrodes are formed on substantially the same plane and the difference between the length of a perpendicular which is extended downwardly onto an anode surface from a first points which is an arbitrary point on the cathode, and the length of a perpendicular which is extended downwardly onto the anode surface from a second points which is an arbitrary point on the control electrode closest to the first point on the cathode, is equal to or smaller than either larger film thickness out of the film thickness of the cathode at the first point and the film thickness of the control electrode at the second point.

9. A liquid crystal display device according to claim 5, wherein a main component of an electron emission material which directly generates electron emission out of a material which constitutes the cathodes is selected from a group consisting of carbon nanotubes, fine carbon fibers, diamond and diamond-like carbon.

10. A liquid crystal display device according to claim 5, wherein the flat panel backlight which is capable of changing at least one of the number of divisions of the light emitting surface and the flickering periods of respective divided regions in response to at least one of selection signals from the outside and selection signals obtained based on a video signal to be displayed.

11. A liquid crystal display device according to claim 5, wherein the light emitting strength of the phosphor of the flat panel backlight is allowed to select a plurality of set values, and
the liquid crystal display device includes a drive device which is capable of controlling, at the time of driving the pixels in the inside of the liquid crystal element, the light emitting strength of a region corresponding to the light emitting surface of the flat panel backlight and the optical transmissivity of the pixels in the inside of the liquid crystal element.
